(19) United States
(12) Patent Application Publication
(10) Pub. No.: US 2025/0289326 A1
(43) Pub. Date: Sep. 18, 2025

(54) WIRELESS CHARGING SYSTEM FOR AUTONOMOUS ROBOTS

(71) Applicant: Dubai Future Foundation, Dubai (AE)

(72) Inventors: Layth Mahdi, Dubai (AE); Mishari Alarfaj, Dubai (AE)

(73) Assignee: Dubai Future Foundation, Dubai (AE)

(21) Appl. No.: 19/079,938

(22) Filed: Mar. 14, 2025

Related U.S. Application Data
(60) Provisional application No. 63/565,884, filed on Mar. 15, 2024.

(51) Int. Cl. B60L 53/12; B60L 53/37; B60L 58/12; H02J 7/00; H02J 7/14; H02J 50/10; H02J 50/80; H02J 50/90

(52) U.S. Cl. CPC B60L 53/12; B60L 53/37; B60L 58/12; H02J 7/00038; H02J 7/0048; H02J 7/14; H02J 50/10; H02J 50/80; H02J 50/90; H02J 2310/48

(57) ABSTRACT

A wireless charging system and method is described for an outdoor autonomous robot. The system comprises a stationary charging unit, a stationary charging pad connected to the stationary charging unit, a mobile charging pad attached to the autonomous robot for capturing wireless energy transferred from the stationary charging pad, and a mobile charging unit connected to the mobile charging pad for translating the wireless energy for a battery of the autonomous robot. The mobile charging unit is adapted to communicate with the stationary charging unit for contactless and wireless charging of the autonomous robot from more than one direction of alignment in between the stationary charging pad and the mobile charging pad.

### CROSS-REFERENCE TO RELATED APPLICATIONS

This application claims the benefit of U.S. Provisional Patent Application Ser. No. 63/565,884, filed Mar. 15, 2024, entitled “WIRELESS CHARGING SYSTEM FOR AUTONOMOUS ROBOTS”, the content of which is incorporated herein by reference in its entirety.

### TECHNICAL FIELD

The present description relates to a wireless charging system and, more particularly, to a wireless charging system for outdoor autonomous robots.

### BACKGROUND

Mobile or autonomous robots are becoming increasingly popular in a variety of environments, particularly for outdoor usage. Autonomous robots for outdoor use are designed to operate independently in external environments, which can deliver goods, packages or other services, including but not limited to cleaning robots, food delivery robots, luggage delivery robots, and much more. Autonomous robots for outdoor use is a rapidly growing field with the potential to revolutionize the industry.

However, as the autonomous driving technology evolves, many existing autonomous robots still rely on charging solutions that involve human intervention. For example, the autonomous robot may use a manual charging plug which requires a human to manually plug in a charging cable to the robot. Another existing charging solution involves hot-swappable, which is a technique for replacing a battery without turning off the device it powers. A human would physically change the empty battery with a new one and charge the empty one in a separate charging station. Hot-swappable batteries allow the robots to continue functioning but typically incur higher costs compared to traditional batteries. This is primarily due to the additional safety features, circuitry, and specialized connectors required for hot-swapping. Despite safety features, hot-swappable batteries still pose potential safety risks. Improper handling or malfunctioning components could lead to electrical hazards, sparks, or even fires.

Yet further, both manual charging and hot-swapping require human intervention, which is expensive and time-consuming, and also contradicts the goal of autonomous mobile robots.

There is therefore a need to provide a better or alternative solution to charging an autonomous robot in an outdoor setting.

### SUMMARY

The following presents a summary of some aspects or embodiments of the disclosure in order to provide a basic understanding of the disclosure. This summary is not an extensive overview of the disclosure. It is not intended to identify key or critical elements of the disclosure or to delineate the scope of the disclosure. Its sole purpose is to present some embodiments of the disclosure in a simplified form as a prelude to the more detailed description that is presented later.

In accordance with one aspect of the present disclosure, a wireless charging system for an outdoor autonomous robot is described. The wireless charging system comprises a battery, a stationary charging unit, a stationary charging pad connected to the stationary charging unit, a mobile charging pad attached to the autonomous robot for capturing wireless energy transferred from the stationary charging pad, and a mobile charging unit connected to the mobile charging pad for translating the wireless energy for a battery of the autonomous robot. The mobile charging unit is adapted to communicate with the stationary charging unit for contactless and wireless charging of the autonomous robot from more than one direction of alignment in between the stationary charging pad and the mobile charging pad.

In some embodiments, the mobile charging pad is fixedly attached on the autonomous robot at one of a front, rear, left, right and bottom sides of a frame of the autonomous robot.

In some embodiments, the stationary charging unit or the stationary charging pad comprises embedded primary coils and the mobile charging pad comprises embedded secondary coils, and the primary and secondary coils act as interface for data transfer between the mobile charging unit and the stationary charging unit.

In some embodiments, the mobile charging unit is adapted to communicate with the stationary charging unit to align the stationary charging pad and the mobile charging pad using infrared sensors.

In some embodiments, the wireless charging system further comprises a Battery Management System (BMS) for controlling a charging process and protecting the battery.

In some embodiments, the mobile charging unit is adapted to communicate with the stationary charging unit for contactless and wireless charging of the autonomous robot with an air gap of between zero to 40 mm between the stationary charging pad and the mobile charging pad.

In some embodiments, the mobile charging unit is adapted to communicate with the stationary charging unit for contactless and wireless charging of the autonomous robot with a tolerance deviating from alignment of the stationary charging pad and the mobile charging pad.

In some embodiments, the tolerance deviating from alignment of the stationary charging pad and the mobile charging pad is within a lateral displacement of 30 mm in either x or y direction.

In some embodiments, the battery is a lithium iron phosphate (LFP) battery.

In accordance with another aspect of the present disclosure, a method of charging of an outdoor autonomous robot by induction is described. The robot comprises a battery; a mobile charging pad attached to the autonomous robot for capturing wireless energy transferred from a stationary charging pad by induction; and a mobile charging unit coupled to the mobile charging pad for translating the wireless energy for use of the battery. The method comprises: the robot autonomously aligning the mobile charging pad to be within a tolerance of the stationary charging pad; and the mobile charging unit communicating with a stationary charging unit connected to the stationary charging pad, causing a wireless and contactless charging process of the robot to start. The mobile charging pad is fixedly attached to the autonomous robot at one of a front, rear, left, right and bottom sides.

In some embodiments, the method further comprises the robot recognizing a pattern on the stationary charging unit or stationary charging pad as the robot approaches the stationary charging unit, and the robot autonomously aligning the mobile charging pad to be within the tolerance of the stationary charging pad using the pattern.

In some embodiments, the tolerance comprises an air gap between the stationary charging pad and the mobile charging pad of zero to 40 mm.

In some embodiments, the tolerance comprises a lateral displacement of 30 mm in either x or y direction.

In some embodiments, the robot autonomously aligning the mobile charging pad to be within the tolerance of the stationary charging pad comprises aligning infrared sensors to ensure communication between the robot and the stationary charging unit.

In some embodiments, the method further comprises using a Battery Management System (BMS) to control the wireless and contactless charging process.

In some embodiments, the method further comprises exchanging measurements and parameters to regulate the wireless and contactless charging process to transition to a charging mode.

In some embodiments, the method further comprises the robot autonomously terminating the charging process by the robot separating the mobile charging pad from the stationary charging pad.

In some embodiments, the method further comprises detecting a state of charge (SOC) of the battery, and autonomously aligning the mobile charging pad to the stationary charging pad when it is detected that the SOC is below a threshold.

In some embodiments, the method further comprises determining whether the robot is free, and autonomously aligning the mobile charging pad to the stationary charging pad when it is determined that the robot is free.

### BRIEF DESCRIPTION OF THE DRAWINGS

These and other features of the disclosure will become more apparent from the description in which reference is made to the following appended drawings.

FIG. 1 is a systematic diagram of a wireless charging system of an autonomous robot, according to one embodiment of the description;

FIG. 2 is a front perspective view of the wireless charging system of an autonomous robot, according to one embodiment of the description;

FIG. 3 is a side elevation view of FIG. 2;

FIG. 4 is a rear perspective view of the wireless charging system of an autonomous robot, according to another embodiment of the description;

FIG. 5(A) is a front perspective view of the wireless charging system of an autonomous robot, showing a placement of the wireless charging pad on the bottom side of the robot;

FIG. 5(B) is a rear perspective view of the wireless charging system of an autonomous robot, showing a placement of the wireless charging pad on the front side of the robot;

FIG. 5(C) is a front perspective view of the wireless charging system of an autonomous robot, showing a placement of the wireless charging pad on the right side of the robot;

FIG. 5(D) is a rear perspective view of the wireless charging system of an autonomous robot, showing a placement of the wireless charging pad on the back side of the robot;

FIG. 5(E) is a rear perspective view of the wireless charging system of an autonomous robot, showing a placement of the wireless charging pad on the left side of the robot;

FIG. 6(A) is a top view of the charging pads showing an allowed lateral displacement in both x and y directions;

FIG. 6(B) is a cross-section view of the charging pads showing an air gap between the charging pads in the z direction;

FIG. 7(A) is a top view of the charging pads aligned with each other;

FIG. 7(B) is a cross-section view of the charging pads aligned with each other;

FIG. 8(A) is a top view of the charging pads aligning themselves from a first direction with respect to each other, according to one embodiment of the description;

FIG. 8(B) is a top view of the charging pads aligning themselves from a second direction with respect to each other, according to one embodiment of the description;

FIG. 8(C) is a top view of the charging pads aligning themselves from a third direction with respect to each other, according to one embodiment of the description;

FIG. 8(D) is a top view of the charging pads aligning themselves from a fourth direction with respect to each other, according to one embodiment of the description;

FIG. 9 is a flowchart of a method of autonomous charging of a robot, according to one embodiment of the description; and

FIG. 10 is a flowchart of a method of autonomous charging of a robot, according to one embodiment of the description.

### DETAILED DESCRIPTION

The following detailed description contains, for the purposes of explanation, various illustrative embodiments, implementations, examples and specific details in order to provide a thorough understanding of the disclosure. It is apparent, however, that the disclosed embodiments may be practiced, in some instances, without these specific details or with an equivalent arrangement. The description should in no way be limited to the illustrative implementations, drawings, and techniques illustrated below, including the exemplary designs and implementations illustrated and described herein, but may be modified within the scope of the appended claims along with their full scope of equivalents.

Described herein includes a wireless charging system or solution for the autonomous robots, particularly in an outdoor setting, which enables the autonomous robots to autonomously charge their batteries without human intervention. The described embodiments provide a contactless and multi-directional charging system for an autonomous robot by induction.

According to various embodiments of the description, a wireless charging system for an autonomous robot is described which comprises a stationary charging unit, a stationary charging pad connected to the stationary charging unit, a mobile charging pad, and a mobile charging unit connected to the mobile charging pad. For the purposes of this description, the stationary charging unit can sometimes be referred to as the “stationary charger”, or “charging station”; and the mobile charging unit can sometimes be referred to as the “wireless charger”, or “mobile charger”. The mobile charging pad can be referred to as the “wireless charging pad”; and the mobile charging unit may be referred to as the “mobile charging electronics”, or “robot charging electronics”. The mobile charging unit and the stationary charging unit may be simplified individually or collectively as the “charger”.

According to various embodiments of the description, the mobile charging pad can be installed, fixedly attached or secured to the autonomous robot at one of a front, rear, left, right and bottom side of the robot. The mobile charging unit is adapted to communicate with the stationary charging unit for autonomous and wireless charging of the autonomous robot from more than one direction of alignment between the stationary charging pad and the mobile charging pad.

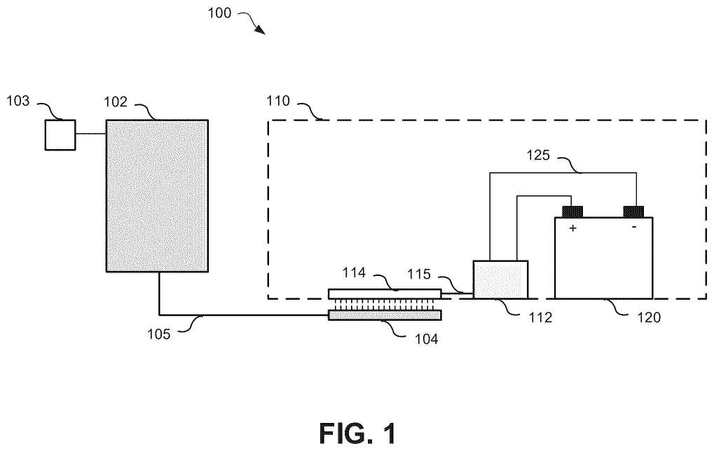

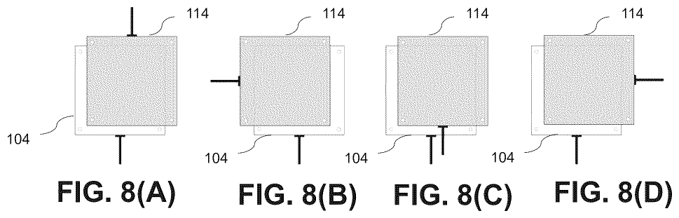

Embodiments are described below, by way of example only, with reference to FIGS. 1-10. Reference numerals have been referred to facilitate understanding and are not intended to limit the scope of the present invention in any manner.

FIG. 1 shows a wireless charging system 100 for an autonomous robot 110 according to one embodiment of the description.

The wireless charging system 100 comprises a stationary charging unit or station 102 and a stationary charging pad 104. The stationary charging pad 104 can be connected to the stationary charging unit 102 via a charging coil 105. The stationary charging unit 102 serves as the primary charging station and interface for the autonomous robots 110, such as outdoor autonomous robots. The stationary charging unit 102 may be connected to or otherwise powered by an A/C power source 103. The stationary charging pad 104 can be equipped with inductive charging technology, which enables wireless energy transfer between the pad 104 and the robot 110.

The wireless charging system 100 also comprises a mobile charging unit or electronics 112 and a mobile charging pad 114. The mobile charging pad 114 is installed, fixedly attached, or secured to the autonomous robot 110. The mobile charging pad 114 can capture the wireless energy transferred from the stationary charging pad 104.

Referring to FIG. 1, The mobile charging unit 112 can be connected to the mobile charging pad 114 via a charging coil 115. The mobile charging unit 112 is a portable charging device coupled to or otherwise housed in the autonomous robot 110. The mobile charging unit 112 is connected to one or more batteries 120 via one or more battery charging wires 125 and the mobile charging unit 112 is adapted to translate the wireless energy received from the mobile charging pad 114 for use of the battery 120.

According to various embodiments of the description, the wireless charging system 100 uses electromagnetic induction to provide electricity to the autonomous robot 110. The stationary charging pad 104 can comprise one or more transmitter coils embedded therein and the mobile charging pad 114 can comprise one or more receiver coils embedded therein. The wireless power transfer between the stationary charging pad 104 and the mobile charging pad 114 can be performed by generating magnetic fields that transfer electrical energy by wireless induction from the transmitter coils of the stationary charging pad 104 to the receiver coils of the mobile charging pad 114.

According to one embodiment of the description, the stationary charging unit 102 and the mobile charging unit 112 can be equipped with controller area network (CANBus) communication capabilities, facilitating comprehensive monitoring and control of the charging system 100 and the health of the battery 120, ensuring seamless operation and maintenance.

According to one embodiment of the description, the mobile charging pad 114 could be installed, attached, or secured at one of a bottom, front, rear, left and right side of the robot 110. The stationary charging pad 104 could be installed on the ground, or on the side of a wall.

According to one embodiment of the description, the battery 120 is a lithium-ion battery, e.g., a lithium iron phosphate (LFP) battery. It should be understood that other types of rechargeable battery can be used for the purposes of the wireless charging system, in addition to one or more LFP batteries.

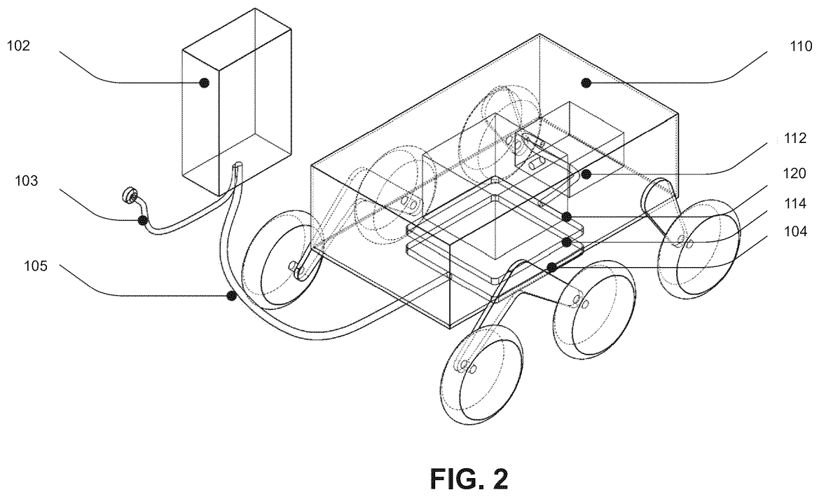

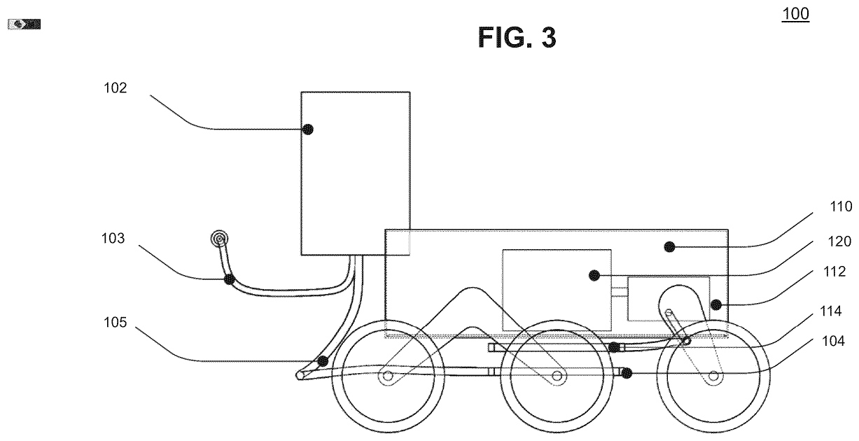

FIG. 2 shows a front perspective view of one embodiment of the wireless charging system 100; and FIG. 3 shows a side elevation view of the wireless charging system 100 as shown in FIG. 2.

As illustrated in FIGS. 1-3, the embodiment of the wireless charging system 100 includes the wireless charging pad 114 installed or fixedly attached to a bottom side of the robot 110.

FIG. 4 is a rear perspective view of the wireless charging system 100 according to another embodiment of the description. This embodiment of the wireless charging system 100 includes the wireless charging pad 114 installed or fixedly attached to a side (left) of the robot 110.

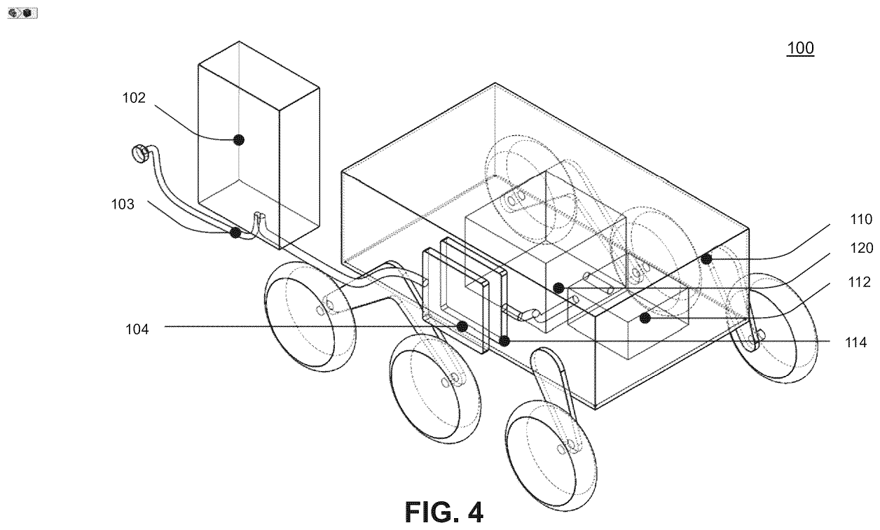

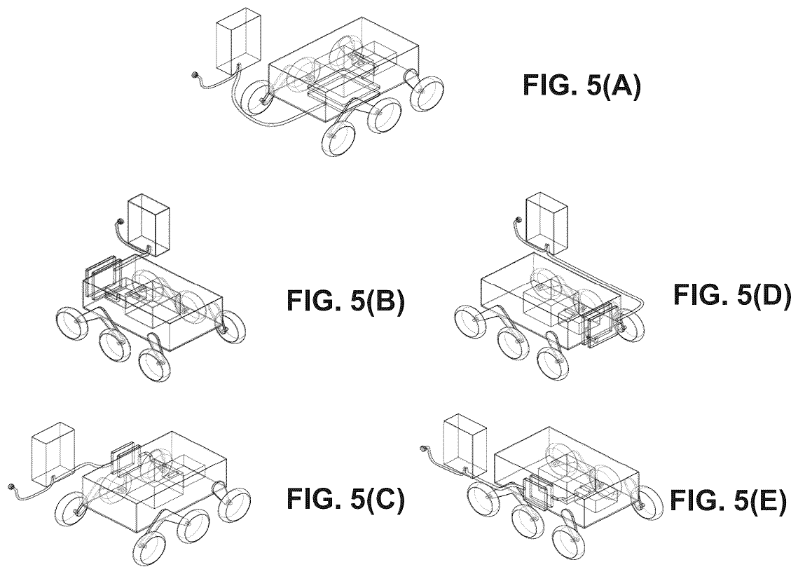

FIG. 5 shows various placements of the wireless charging pad 114 according to different embodiments of the description, where the wireless charging pad 114 could be placed on different sides of the robot, e.g., front, back, bottom, right, or left side of the frame of the robot 110.

In particular, FIG. 5A shows an embodiment of the wireless charging system, where the wireless charging pad is installed on the bottom side of the robot 110; FIG. 5B shows an embodiment of the wireless charging system, where the wireless charging pad is installed on the front side of the robot 110; FIG. 5C shows an embodiment of the wireless charging system, where the wireless charging pad is installed on the right side of the robot 110; FIG. 5D shows an embodiment of the wireless charging system, where the wireless charging pad is installed on the back side of the robot 110; and FIG. 5E shows an embodiment of the wireless charging system, where the wireless charging pad is installed on the left side of the robot 110.

According to various embodiments of the wireless charging system, the mobile charging pad 114 can be placed near the stationary charging pad 104 without needing to be precisely or perfectly aligned. Instead, the mobile charging unit 112 is adapted to communicate with the stationary charging unit 102 for contactless and wireless charging of the autonomous robot 110 with a tolerance deviating from alignment of the stationary charging pad 104 and the mobile charging pad 114.

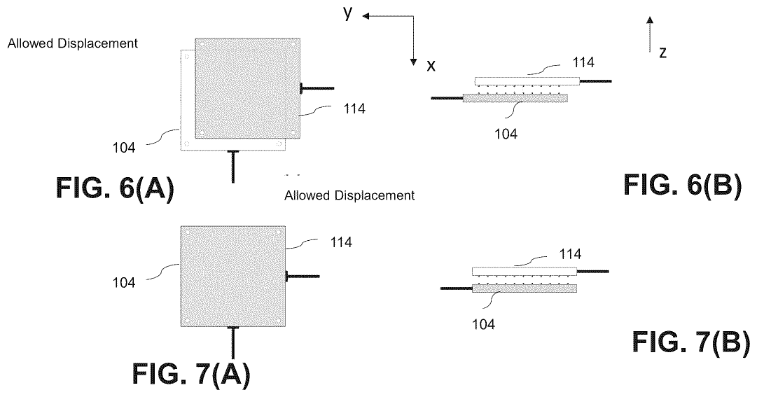

FIG. 6A illustrates the charging pads 104, 114 with an allowed lateral displacement in the x direction and an allowed lateral displacement in the y direction; and FIG. 6B illustrates an air gap (in the z direction) between the charging pads 104, 114. The tolerance deviating from alignment of the stationary charging pad 104 and the mobile charging pad 114 can be for example, a maximum Z tolerance of 40 mm, and/or a maximum X/Y tolerance of 30 mm.

Precise alignment of the charging pads 104, 114 can be seen in FIG. 7. In particular, FIG. 7A is a top view of the charging pads 104, 114 aligned precisely with each other; and FIG. 7B is a cross-section view of the charging pads 104, 114 showing the precise alignment.

According to various embodiments of the description, the mobile charging unit 112 is adapted to communicate with the stationary charging unit 102 for contactless and wireless charging of the autonomous robot 110 from more than one direction of alignment between the stationary charging pad 104 and the mobile charging pad 114.

FIG. 7A shows the charging pads 104, 114 aligning themselves from a first direction with respect to each other; FIG. 7B shows the charging pads 104, 114 aligning themselves from a second direction with respect to each other; FIG. 7C shows the charging pads 104, 114 aligning themselves from a third direction with respect to each other; and FIG. 7D shows the charging pads 104, 114 aligning themselves from a fourth direction with respect to each other. It should be understood that the figures only set out several exemplary ways of aligning the charging pads 104, 114, and it is not necessary that the description be limited strictly to those examples, but could be changed dependent on the manners in which the stationary charging pad 104 and the mobile charging pad 114 are installed.

The charger system 100 therefore offers versatile installation options, enabling the robot 110 to autonomously and wirelessly charge itself from various angles without requiring human intervention.

According to some embodiments of the description, the stationary charging unit 102 or stationary charging pad 104 can include a pattern (for example, a certain graphical bar code, logo, or the like) for recognition by a sensor or camera of the autonomous robot 110. As the autonomous robot 110 is approaching the stationary charging unit 102, the pattern can be used to facilitate alignment of the stationary charging pad 104 and the mobile charging pad 114.

The autonomous robot 110 may further comprise infrared sensors used for alignment between the stationary charging pad 104 and the mobile charging pad 114.

According to various embodiments of the description, the mobile charging unit or electronics 112 can be connected to the robot battery 120 through a Battery Management System (BMS). The BMS can play an important role in communicating between the battery 120 and the wireless charging system 100, ensuring safe and efficient charging. This communication involves exchanging various parameters and information to optimize the charging process and protect the battery 120 from damage.

Some of the information exchanged between the battery 120 and the charger 102, 112 can include:
Battery State of Charge (SOC): The BMS continuously monitors the battery 120's SOC which indicates the percentage of its available energy. This information is important for the charger 102, 112 to determine the charging duration and adjust the charging current accordingly.
Battery Temperature: The BMS monitors the battery 120's temperature, which can significantly impact its charging behavior. Overheating can lead to battery degradation and safety hazards. The charger 102, 112 can use this information to adjust the charging current and prevent overheating.
Battery Voltage: The BMS monitors the battery 120's voltage, ensuring it stays within safe limits during charging. The charger 102, 112 can use this information to adjust the charging voltage accordingly.
Battery Health: The BMS continuously assesses the battery 120's health, including factors like cell balancing, impedance, and remaining capacity. This information helps the charger 102, 112 modify the charging parameters to optimize battery life and performance.
Charging Parameters: The BMS communicates the recommended charging parameters, such as maximum voltage, current, and temperature limits, to the charger 102, 112. The charger can adhere to these parameters to ensure safe and efficient charging.

While specific examples of information is described above with reference to the BMS, it should be understood that other information can be exchanged between the charger 102, 112 and the battery 120 to control and optimize the charging process and to protect the battery.

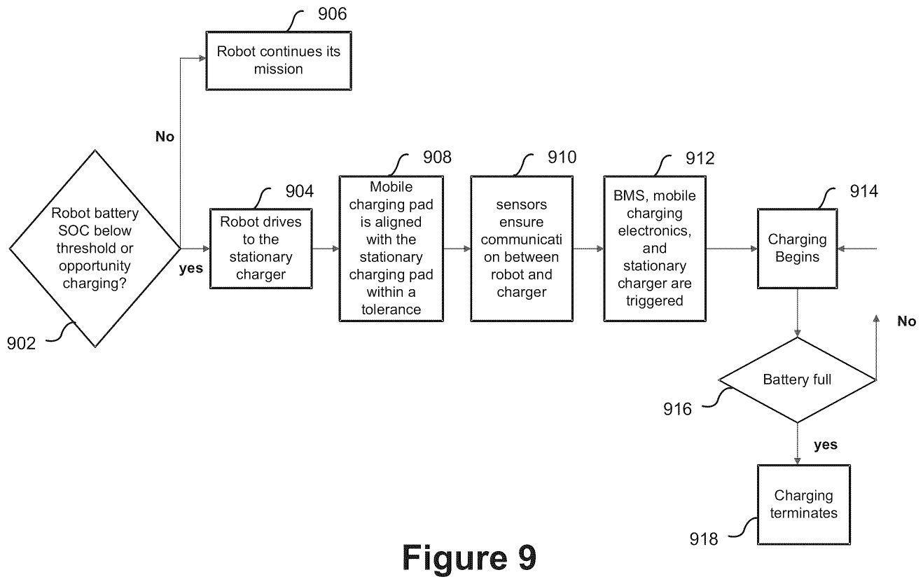

FIG. 9 illustrates a method of autonomous charging of a robot, according to one embodiment of the description.

According to the embodiment, the method can include detecting (902), by the robot and by e.g., the BMS, whether the SOC of the battery is below a threshold, or whenever the robot is free (opportunity charging). When it is determined that the SOC of the battery is below the threshold, or if there is an opportunity for charging, the robot proceeds to drive (904) to the stationary charger. Otherwise, the robot will continue 906 its mission.

As the robot drives (904) to the stationary charger, the robot is adapted to align 908 the mobile charging pad with the stationary charging pad within a tolerance. As described above, the tolerance can comprise an air gap in the z direction between the stationary charging pad and the mobile charging pad of zero to 40 mm. In addition, the tolerance can comprise a lateral displacement of 30 mm in either x or y direction.

In aligning the charging pads, the robot may recognize a pattern such as a code or logo on the stationary charging unit or pad to be used for alignment. For example, the robot may be adapted to recognize the stationary charger through use of one or more cameras and by recognizing a certain graphical bar code or logo, and start positioning itself as it reaches the stationary charger.

Alternatively or additionally, the robot can include infrared sensors and adapted to align the infrared sensors to ensure communication between the robot and the stationary charger.

As discussed above, the charger units communicate with each other to make sure the pads are positioned. The charger units can tolerate a certain lateral and/or vertical displacement for charging to be activated.

When the charging pads are aligned within the tolerance, the BMS, mobile charging electronics, and stationary charger can be triggered (912). After properly positioning the coils within a suitable distance, the data transfer interface embedded in the primary and secondary coils initiates communication between the stationary and mobile chargers and communication between the mobile charger, the stationary charger, and/or BMS start, thereby initiating (914) the wireless and contactless charging process.

The charging process will continue until it is determined that the battery is full at step (916). Once the battery is full, the wireless charging system can terminate (918) the charging process, for example, by the robot separating the mobile charging pad from the stationary charging pad. When the mobile charging pad is separated from the stationary charging pad, communication between the mobile charging unit and the stationary charging unit is disrupted, causing the wireless charging process to automatically halt. Wireless charging will stop when the battery is full without the need for the robot to move.

The method can also include exchanging measurements and parameters to regulate the wireless charging process to transition to and from a charging mode, by way through e.g., the BMS as explained above.

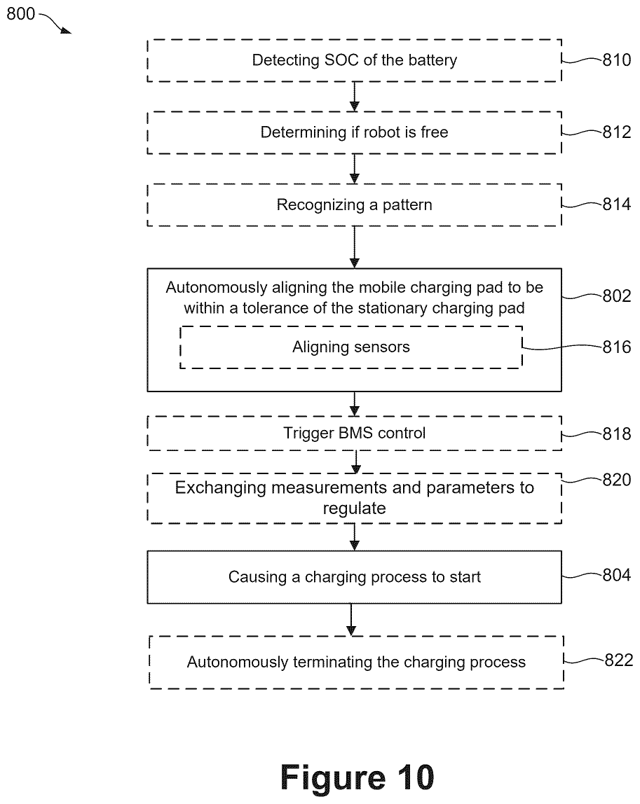

FIG. 10 is a flowchart of a method 800 of autonomous charging of a robot, according to some embodiments of the description.

The method comprises the robot autonomously aligning (802) the mobile charging pad to be within a tolerance of the stationary charging pad; and the mobile charging unit communicating with a stationary charging unit connected to the stationary charging pad, causing (804) a wireless and contactless charging process of the robot to start. As described above, the mobile charging pad is fixedly attached to the autonomous robot at one of a front, rear, left, right and bottom sides.

In some embodiments, the method 800 may comprise detecting (810) a SOC of the battery, and autonomously aligning (802) the mobile charging pad to the stationary charging pad when it is detected that the SOC is below a threshold.

Alternatively or additionally, the method 800 may comprise determining (812) whether the robot is free, and autonomously aligning (802) the mobile charging pad to the stationary charging pad when it is determined that the robot is free.

In some embodiments, a pattern may be recognized (814) on the stationary charging unit or stationary charging pad as the robot approaches the stationary charging unit, and the robot autonomously aligning (802) the mobile charging pad to be within the tolerance of the stationary charging pad may use the recognized pattern.

In some embodiments, the tolerance may comprise an air gap between the stationary charging pad and the mobile charging pad of zero to 40 mm. Concurrently or alternatively in some embodiments, the tolerance may comprise a lateral displacement of 30 mm in either x or y direction.

In some embodiments, the robot autonomously aligning (802) the mobile charging pad to be within the tolerance of the stationary charging pad may comprise aligning (816) sensors such as infrared sensors to ensure communication between the robot and the stationary charging unit.

In some embodiments, the method 800 may further comprise triggering (818) a BMS to control the wireless and contactless charging process.

In some embodiments, the method 800 may further comprise exchanging (820) measurements and parameters, e.g., via the BMS, to regulate the wireless and contactless charging process to transition to a charging mode.

In some embodiments, the method 800 may further comprise the robot autonomously terminating (822) the charging process by the robot separating the mobile charging pad from the stationary charging pad, such as when it is detected that the charging process is completed.

The described system according to embodiments therefore allows for efficient, autonomous, and versatile charging solutions for autonomous robots, such as outdoor autonomous robots.

Efficiency: Conventional charging methods for autonomous robots may be slow and inefficient, or requires human intervention which does not allow for full autonomy.

In contrast, the wireless charging system and method according to the various embodiments permits a full autonomous cycle of the robot to happen, in that the robot can go on dock over the charger to transfer energy between the pads, and continue its mission after the charging process is completed. Unless it breaks down, the robot can be dependent on itself.

As described above, the wireless charger according to the description can be capable of charging the battery at a high amplitude, thereby reducing robot downtime and providing the wireless charging more efficiently.

Versatility: The wireless charging system and method according to various embodiments enables charging from various angles and positions without the need for precise positioning for successful charging to complete.

The wireless charging system according to the embodiments also realizes the autonomous charging process without making electrical contact with a dock or plug, eliminating physical contacting charging pads which can have high potential of collecting metal dust and introducing dangerous electric sparks.

Speed: While conventional charging methods for autonomous delivery robots (such as last-mile delivery robots) can be time-consuming, the wireless charging system according to some embodiments can empower the robot 110 to achieve a rapid supercharge, while maintaining a maximum Z tolerance of 40 mm and XY tolerance of 30 mm. This high charging rate can significantly reduce the time required to recharge the robot's batteries. This speed advantage can also address an important issue in the field of delivery robotics—minimizing downtime. Faster charging means that robots can spend more time in active operation, completing deliveries, and contributing to increased efficiency and productivity. The reduced downtime results in a more streamlined and cost-effective delivery process.

Compared to existing charging solutions, which often involve slower charging rates, the described system according to some embodiments can provide a notable competitive edge by allowing robots to get back on the road more quickly, improving the overall efficiency of outdoor operations.

While some embodiments may make reference to autonomous delivery robots, it should be understood that the system and method as described can apply to various other outdoor autonomous robots and has the potential for various commercial and industrial applications including, but are not limited to: autonomous lawn care robot, autonomous cleaning and maintenance robots, autonomous waste collection, autonomous search and rescue robots, and the like.

These can demonstrate the use of having a moving autonomous outdoor robot equipped with wireless charging technology to create new commercial services, enhance existing industries, and provide full autonomy capabilities, from agriculture to entertainment and disaster response.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g., “such as”) is intended merely to better illustrate or describe embodiments of the disclosure and is not intended to limit the scope of the disclosure unless otherwise claimed.

Although several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A wireless charging system for an outdoor autonomous robot, comprising:
a battery;
a stationary charging unit;
a stationary charging pad connected to the stationary charging unit;
a mobile charging pad attached to the autonomous robot for capturing wireless energy transferred from the stationary charging pad; and
a mobile charging unit connected to the mobile charging pad for translating the wireless energy for a battery of the autonomous robot,
wherein the mobile charging unit is adapted to communicate with the stationary charging unit for contactless and wireless charging of the autonomous robot from more than one direction of alignment in between the stationary charging pad and the mobile charging pad.

2. The wireless charging system according to claim 1, wherein the mobile charging pad is fixedly attached on the autonomous robot at one of a front, rear, left, right and bottom sides of a frame of the autonomous robot.

3. The wireless charging system according to claim 1, wherein the stationary charging unit or the stationary charging pad comprises embedded primary coils and the mobile charging pad comprises embedded secondary coils, and the primary and secondary coils act as interface for data transfer between the mobile charging unit and the stationary charging unit.

4. The wireless charging system according to claim 1, wherein the mobile charging unit is adapted to communicate with the stationary charging unit to align the stationary charging pad and the mobile charging pad using infrared sensors.

5. The wireless charging system according to claim 1, further comprising a Battery Management System (BMS) for controlling a charging process and protecting the battery.

6. The wireless charging system according to claim 1, wherein the mobile charging unit is adapted to communicate with the stationary charging unit for contactless and wireless charging of the autonomous robot with an air gap of between zero to 40 mm between the stationary charging pad and the mobile charging pad.

7. The wireless charging system according to claim 1, wherein the mobile charging unit is adapted to communicate with the stationary charging unit for contactless and wireless charging of the autonomous robot with a tolerance deviating from alignment of the stationary charging pad and the mobile charging pad.

8. The wireless charging system according to claim 7, wherein the tolerance deviating from alignment of the stationary charging pad and the mobile charging pad is within a lateral displacement of 30 mm in either x or y direction.

9. The wireless charging system according to claim 1, wherein the battery is a lithium iron phosphate (LFP) battery.

10. A method of autonomous charging of an outdoor autonomous robot by induction, the robot comprising: a battery; a mobile charging pad attached to the autonomous robot for capturing wireless energy transferred from a stationary charging pad by induction; and a mobile charging unit coupled to the mobile charging pad for translating the wireless energy for use of the battery, wherein the method comprises:
the robot autonomously aligning the mobile charging pad to be within a tolerance of the stationary charging pad; and
the mobile charging unit communicating with a stationary charging unit connected to the stationary charging pad, causing a wireless and contactless charging process of the robot to start,
wherein the mobile charging pad is fixedly attached to the autonomous robot at one of a front, rear, left, right and bottom sides.

11. The method according to claim 10, further comprising the robot recognizing a pattern on the stationary charging unit or stationary charging pad as the robot approaches the stationary charging unit, and the robot autonomously aligning the mobile charging pad to be within the tolerance of the stationary charging pad using the pattern.

12. The method according to claim 10, wherein the tolerance comprises an air gap between the stationary charging pad and the mobile charging pad of zero to 40 mm.

13. The method according to claim 10, wherein the tolerance comprises a lateral displacement of 30 mm in either x or y direction.

14. The method according to claim 10, wherein the robot autonomously aligning the mobile charging pad to be within the tolerance of the stationary charging pad comprises aligning infrared sensors to ensure communication between the robot and the stationary charging unit.

15. The method according to claim 10, further comprising using a Battery Management System (BMS) to control the wireless and contactless charging process.

16. The method according to claim 10, further comprising exchanging measurements and parameters to regulate the wireless and contactless charging process to transition to a charging mode.

17. The method according to claim 10, further comprising the robot autonomously terminating the charging process by the robot separating the mobile charging pad from the stationary charging pad.

18. The method according to claim 10, further comprising detecting a state of charge (SOC) of the battery, and autonomously aligning the mobile charging pad to the stationary charging pad when it is detected that the SOC is below a threshold.

19. The method according to claim 10, further comprising determining whether the robot is free, and autonomously aligning the mobile charging pad to the stationary charging pad when it is determined that the robot is free.
